(19) United States
(12) Patent Application Publication
(10) Pub. No.: US 2023/0240925 A1
(43) Pub. Date: Aug. 3, 2023

(54) SITTING AID DEVICE FOR A BATHROOM FIXTURE

(71) Applicant: Body Health Technologies LLC, Wilmington, DE (US)

(72) Inventor: Lucio Gomes Da Costa, Agno (CH)

(21) Appl. No.: 17/592,415

(22) Filed: Feb. 3, 2022

(51) Int. Cl. A61G 7/10; A47K 13/10

(52) U.S. Cl. CPC A61G 7/1007; A47K 13/10; A61G 7/1044

(57) ABSTRACT

Provided herein is a sitting aid device for bathroom fixtures, such as toilets or bidets, which is combined with at least one first installation surface and comprises: a sitting element, comprising an opening and configured to come into contact with an upper portion of a user's body; a motor operatively combined with said sitting element to move said sitting element between a first position, in which said sitting element is substantially parallel to said first installation surface, and a second position, in which said sitting element is at least partially away from an upper end of said bathroom fixture and is inclined with respect to a plane parallel to said first installation surface; at least one supporting frame to which said sitting element is rotatably constrained; said at least one supporting frame comprising at least one base element configured to come into contact with said first installation surface); and a control unit configured to control said motor; wherein said at least one supporting frame is able to switch from an open configuration, in which said sitting element is away from said base element, so as to be able to house at least partially said bathroom fixture between said sitting element and said base element, and a closed configuration in which said sitting element is moved closer to said base element.

### TECHNICAL FIELD

The present disclosure refers to the field of bathroom fixtures. More particularly, the present disclosure concerns a sitting aid device for bathroom fixtures, such as toilets or bidets, which allows elderly people and/or people with physical or mental disabilities and/or handicaps to facilitate the use of bathroom fixtures.

### BACKGROUND

It is known that people who have certain handicaps or elderly people have problems using bathroom fixtures, since it is not easy for these people to switch from the standing position to the sitting position on the bathroom fixture. Typically, in order to use bathroom fixtures, these individuals need other people to assist them in performing such functions.

Therefore, a need exists for a sitting aid device for bathroom fixtures, which would facilitate the use thereof by elderly people or people with disabilities, even without resorting to the assistance of third parties, such as caregivers and/or nurses.

In order to solve this problem, systems integrated in bathroom fixtures have been proposed; however, such systems are complex, require important installations, and are generally very expensive.

Documents KR20160142766, U.S. Pat. No. 5,819,325, US2017347845 describe known sitting aid devices for bathroom fixtures.

Previous approaches to sitting aid devices for bathroom fixtures, once installed, can be generally removed and transported only with difficulty, due to their structural complexity, bulk, and weight. Further, the movement of previous sitting aid devices for bathroom fixtures, once installed, requires complete disassembly.

Therefore, a need exists for a sitting aid device for bathroom fixtures, which can be easily and effortlessly applied to existing bathroom fixtures and which can be disassembled and transported in order to be used on a bathroom fixture placed in a different place.

Therefore, the Applicant also raised the problem of proposing a sitting aid device for bathroom fixtures which is easily reclosable and transportable.

### SUMMARY

Therefore, a first aspect of the disclosure relates to a sitting aid device for bathroom fixtures, such as toilet or bidet, which is combined with at least one first installation surface comprising:
a sitting element, comprising an opening and configured to come into contact with an upper portion of the user's body;
a motor operatively combined with said sitting element to move said sitting element between a first position, in which said sitting element is substantially parallel to said first installation surface, and a second position, in which said sitting element is at least partially away from an upper end of said bathroom fixture and is inclined with respect to a plane parallel to said first installation surface;
at least one supporting frame to which said sitting element is rotatably constrained; said at least one supporting frame comprising at least one base element configured to come into contact with said first installation surface; and
a control unit configured to control said motor means;

wherein:
said at least one supporting frame is able to switch from an open configuration, in which said sitting element is away from said base element, so as to be able to house at least partially said bathroom fixture between said sitting element and said base element, and a closed configuration, in which said sitting element is moved closer to said base element.

The sitting aid device of the present disclosure is of the “servo-assisted” type, i.e., it is able to lift and incline the sitting board of a toilet or bidet, also ensuring the positioning of the sitting board in intermediate stages between a first sitting position and a second working position. This way, the user's hips, buttocks, thighs, knees and legs are very close to the sitting board, thus avoiding the same user's delicate movements in the action of sitting, which can be dangerous or particularly difficult.

The sitting aid device of the present disclosure can advantageously be used by users having different heights, since the sitting board can be brought to the desired height.

The present disclosure, in the aforesaid aspect, may have at least one of the features described below.

In one embodiment, the sitting aid device comprises a sitting element having a substantially annular shape.

Conveniently, the sitting aid device comprises at least one supporting frame provided with at least one front supporting element rotatably constrained to the base element. The front supporting element is able to rotate between a rest position, in which the front supporting element is substantially angularly alongside the base element, and an operating position, in which the front supporting element abuts to support the base element against the sitting element.

Advantageously, at least one supporting frame further comprises at least two rear supporting elements, each of which rotatably constrained at one end to said base element; each of said rear supporting elements being also functionally combined with said sitting element.

Conveniently, each of the at least two rear supporting elements is able to rotate between a rest position, in which the least two rear supporting elements are substantially angularly alongside the base element, and an operating position in which the least two rear supporting elements are angularly away from the base element so as to set at least one rear portion of the sitting element at a height such as to allow the upper surface of the bathroom fixture to be inserted below the sitting element.

In embodiments, each of the at least two rear supporting elements comprises a cylinder piston actuated by a motor to bring said sitting element from the first position to the second position and vice versa.

Advantageously, each cylinder piston comprises two mutually sliding portions actuated by an actuator. In a specific embodiment, the actuator is an electric actuator.

Conveniently, the front element comprises two side uprights and a transverse element arranged between the side uprights; each side upright comprising two telescopic tubular elements configured to vary the position of said transverse element.

Advantageously, in embodiments the device further comprises two side stabilizing devices comprising two pins combined with the rear supporting elements, said pins being movable between a position of engagement with a side wall of said bathroom fixture and a position of disengagement with respect to the bathroom fixture.

In embodiments, the base element comprises two elongated portions configured to be arranged laterally to said bathroom fixture, so as to delimit the base element in a transverse direction, and at least one front connecting portion arranged substantially transversely between said two elongated portions so as to connect them.

In another embodiment, the device comprises two connecting rods configured to be arranged between the base element and the rear supporting elements.

Further characteristics and advantages of the invention will become more apparent from the detailed description of some preferred, but not exclusive, embodiments of a sitting aid device for bathroom fixtures according to the present invention.

### BRIEF DESCRIPTION OF THE DRAWINGS

Such description will be set forth hereinafter with reference to the appended drawings, provided for indicative, and therefore non-limiting, purpose only, wherein:

FIG. 1 shows a sitting aid device, in a first embodiment, in perspective view in a first position “A”, according to the present invention;

FIG. 2 shows a side view of a sitting aid device, in a first embodiment, in a first position “A”;

FIG. 3 shows a side view of a sitting aid device, in a first embodiment, in a second position “B”.

FIG. 4 shows the sitting aid device of FIG. 1, in a closed configuration; and

FIG. 5 shows the sitting aid device of FIG. 1, while it is switching from the closed configuration to the open configuration with the front element and the rear supporting elements partially rotated.

### DETAILED DESCRIPTION

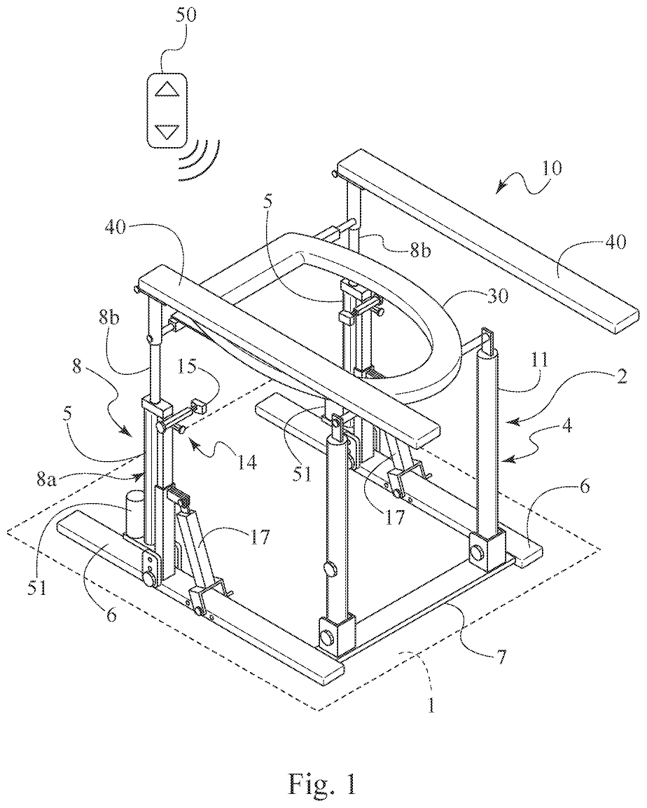

With reference to FIGS. 1-5, a sitting aid device for bathroom fixtures according to the present disclosure is identified by the reference numeral 10. The sitting aid device 10 is positioned on the top of a normal bathroom fixture 20. In embodiments, such bathroom fixture is a toilet. Alternatively, the bathroom fixture 20 is a bidet.

The bathroom fixture 20 is normally installed and extends from a first installation surface 1, which can be identified with the floor of the place where the bathroom fixture 20 is installed. Moreover, in many cases, the place or room in which the bathroom fixture 20 is installed provides for a second installation surface 1′ generally orthogonal to the first installation surface 1 and typically placed behind the bathroom fixture 20.

Once installed, the bathroom fixture 20 identifies a front portion and a rear portion, typically the front portion is a portion most away from the second installation surface 1′, whereas the rear portion is a portion closest to the second installation surface 1′.

The sitting device 10 comprises, on the upper part, a sitting element 30. The sitting element 30 can be annular in shape and provide for an opening.

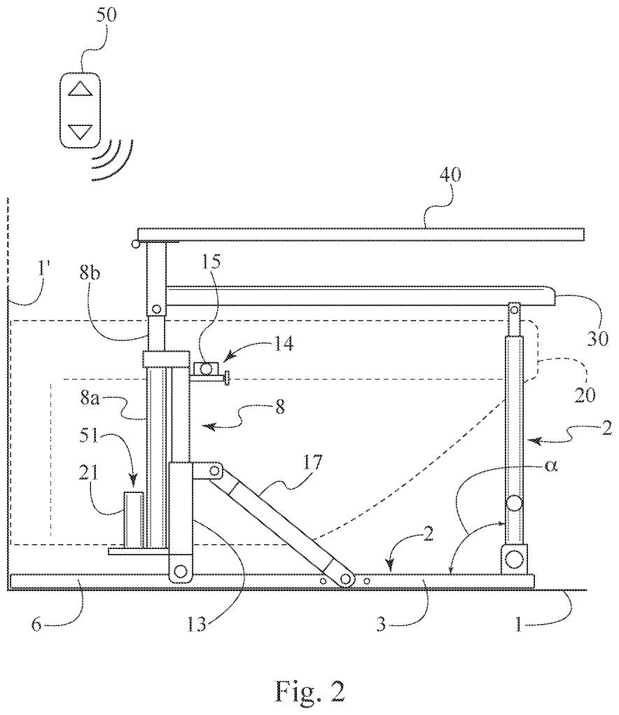

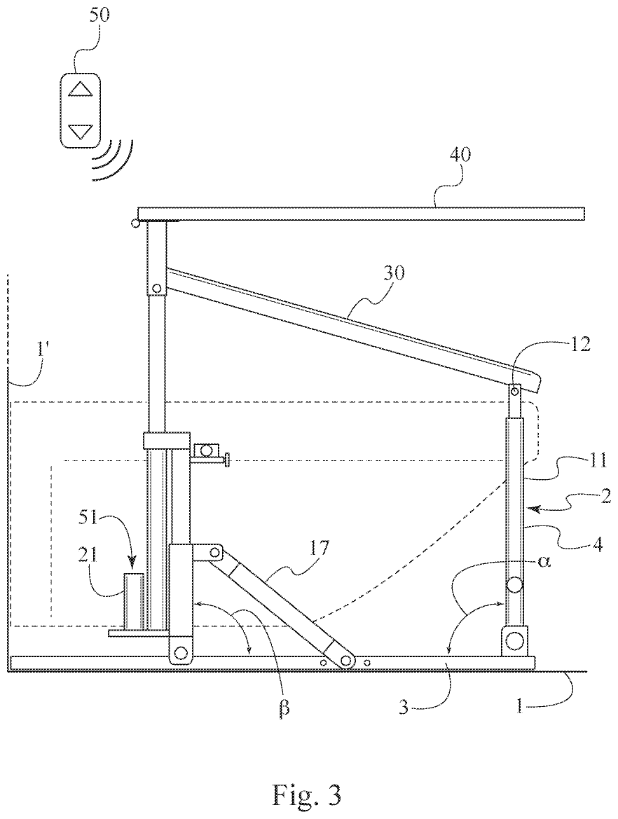

The sitting element 30 comprises a front portion 11, i.e., a portion placed at the front portion of the bathroom fixture 2. The sitting element 30 further comprises a rear portion, placed at the rear portion of the bathroom fixture 20. With reference to FIGS. 1 and 2, a first embodiment of the sitting aid device 10 according to the present disclosure is depicted below. The sitting aid device 10 further comprises a motor operatively combined with the sitting element 30 to move the sitting element between a first position (A), shown in FIGS. 1 and 2, in which the sitting element 30 is substantially parallel to the first installation surface 1, and a second position (B), shown in FIG. 3, in which the sitting element 30 is at least partially away from an upper end of the bathroom fixture 20 and is inclined with respect to a plane parallel to the first installation surface 1.

The sitting aid device 10 further comprises a control unit 50 configured to control the motor 51.

With the sitting device 10 open (shown in FIGS. 1, 2, 3), the sitting element 30 is supported by at least one supporting frame 2. In particular, the sitting element 30 is rotatably constrained to the supporting frame 2.

The supporting frame 2 has at least one base element 3 configured to come into contact with the first installation surface 1, at least one front supporting element 4 hinged to the base element 3 and two rear supporting elements 5 also rotatably constrained to the base element 3.

The rear supporting elements 5 are hinged at a reciprocal end to the sitting element 30, preferably in its rear portion, and at the reciprocal end remaining to the base element 3.

The supporting frame 2 can switch from an open configuration, shown in FIGS. 1 and 2, in which the sitting element 30 is away from said base element 3, so as to be able to house at least partially the bathroom fixture 20 between the sitting element 30 and the base element 3, and a closed configuration, shown in FIG. 3, in which the sitting element 30 is moved closer to the base element 3.

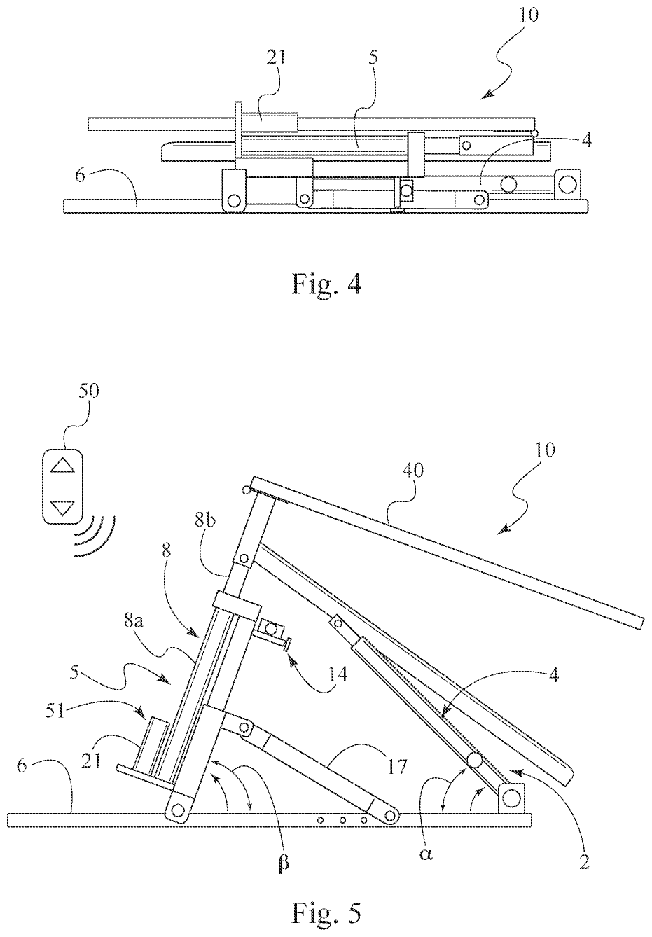

In the closed configuration, shown by way of example in FIG. 4, the sitting aid device 10 assumes dimensions and encumbrances such as to be housed inside a special case or suitcase and to be easily transported, e.g., by a person.

In the embodiment shown in the figures, the base element 3 has a substantially “U” shape so as to be able to at least partially enclose, in plan, the bathroom fixture 20.

In particular, in the embodiments shown in the figures, the base element 3 has a substantially “U” shape configured to at least partially enclose the base of the bathroom fixture.

The base element 3 comprises two side portions 6 and a transverse portion 7 which is arranged transversely to the plan extension direction of the bathroom fixture so as to join the two side portions 6 and to be located, when the sitting aid device 10 is installed, in front of the bathroom fixture 20.

The two side portions 6 extend in the same plan extension direction as the bathroom fixture until they touch the second installation surface 1′, typically orthogonal to the first installation surface 1.

According to an alternative embodiment not shown in the figures, the side portions 6 can each have an element which is telescopically extendible with respect to the free end in order to vary the position of the base element 30 with respect to the second installation surface 1′. The extendible element is in fact that part of the side portion 6 that will come into contact with the second installation surface 1′, by varying the position of the transverse portion 7 with respect to the bathroom fixture 20. Preferably, at the transverse portion 7, the supporting frame 2 further comprises at least one front supporting element 4.

The front supporting element 4 is rotatably constrained to the base element 3. Preferably, the front supporting element 4 is hinged at the transverse portion 7 to the base element 3 so as to be able to rotate between a rest position, in which it is angularly alongside the base element 3, and an operating position in which it abuts to support it against the sitting element 30.

In the embodiment shown in the figures, the front supporting element 4 switches from a rest position, in which it is substantially horizontal, to an operating position in which it is substantially vertical and orthogonal to the first installation surface 1. In detail, the front supporting element 4 switches from a rest position, in which it forms an angle a equal to or less than 25°, preferably less than 10° with respect to said base element 3, to an operating position in which it forms an angle a greater than or equal to 80°, preferably greater than or equal to 90° with the base element 3.

Preferably, the front supporting element 4 comprises two side uprights 11 and a transverse element 12 arranged transversely between the two side uprights 11.

In detail, each side upright 11 is constrained at one end, the upper one, to the transverse element 12 and at the remaining end, the lower one, to the base element 3.

Each side upright 11 comprises two telescopic tubular elements 11a, 11b configured to vertically vary the position of the transverse element 12. For this purpose, the two telescopic tubular elements 11a, 11b have a plurality of corresponding holes arranged at different heights which can be engaged by a removable dowel.

When the sitting aid device 10 is in the open configuration, the transverse element 12 abuts against the sitting element 30, in particular against a front portion of the sitting element 30. The supporting frame 2 further comprises at least two rear supporting elements 5.

Preferably, each rear supporting element 5 is rotatably constrained at one end to the base element 3 and at the remaining end to the sitting element 30, preferably in a rear portion thereof.

Preferably, each rear supporting element 5 is hinged at the base element 3 so as to be able to rotate between a rest position (FIG. 4), in which the rear supporting element 5 is angularly alongside the base element 3, and an operating position (FIGS. 1, 2) in which the rear supporting element 5 is angularly away from the base element 3 so as to place at least one rear portion of the sitting element 30 at a height such as to allow to insert the upper surface of the bathroom fixture 20 below said sitting element 30.

In the embodiment shown in the figures, each rear supporting element 5 switches from a rest position (FIG. 4), in which it forms an angle β equal to or less than 25°, more specifically less than 10° with respect to the base element 3, and an operating position (FIG. 1, 2) in which the rear supporting element 5 forms an angle β greater than or equal to 80°, more specifically greater than or equal to 90° with the base element 3.

Each rear supporting element 5, in the embodiments shown in the figures, comprises a cylinder piston 8 actuated by a motor 51 controlled by a control unit to bring the sitting element 30 from said first position (A) (FIG. 1, 2) to said second position (B) (FIG. 3) and vice versa.

In the embodiment shown in the figures, the motors are represented by two actuators 21, optionally electric actuators, powered by a battery.

Each rear supporting element 5 has an actuator 21. Each actuator 21 is optionally constrained to the base element 3. Each actuator 21 is optionally controlled by the control unit 50.

Each cylinder piston 8 is composed of two mutually sliding portions 8a, 8b. As the mutually sliding portions 8a, 8b of the cylinder piston 8 slide with each other, they move the backward portion 12 of the sitting element 30 away from the first installation surface 1′.

This allows to displace the sitting element 30 between a first position A, in which said sitting element 30 is substantially parallel to the first installation surface 1′ (FIGS. 1, 2) and in contact with an upper end of the bathroom fixture 20, and a second position B (FIG. 3), in which the sitting element 30 is at least partially away from the upper end of said bathroom fixture 20 and is inclined with respect to a plane parallel to the first installation surface 1′.

In this configuration, the control unit 50, which is operated by the user of the sitting aid device 10, actuates the motor 51 and moves the mutually sliding portions 8a, 8b of the cylinder piston 8.

Preferably, the motor 51 acts substantially simultaneously on the mutually sliding portions 8a, 8b. This allows to extend the rear supporting elements 5 substantially simultaneously and, consequently, to lift the rear portion of the sitting element 30, as shown in FIG. 3.

This substantially mutual distancing of the sliding portions 8a, 8b allows the sitting surface 30 to take the desired inclination with respect to a plane parallel to the first installation surface 1′, by acting on the backward portion of the sitting element 30.

Various motors are known in the art and suitable for use in the presently disclosure sitting aid devices. In embodiments, the motor 51 comprises electric actuators. Alternatively, the motor 51 may comprise hydraulic pistons. Alternatively, the motor 51 may comprise at least one electric motor which engages a rack through a pinion. Alternatively, the motor 51 may comprise pneumatic components.

Other embodiments of motors are known in the art and suitable for use in the presently disclosed devices. In the embodiment of the sitting aid device 10 shown in the figures, the motor 51 is connected to the control unit 50 by means of a wireless communication system. In embodiments, this wireless communication system is of the Bluetooth® type. Alternatively, this wireless communication system is of the Zigbee® type. Alternatively, this wireless communication system is of the Wi-Fi type.

Alternatively, the motor 51 is connected to the control unit 50 by means of a cable adapted for data transport.

In the embodiments shown in the figures, the sitting aid device comprises two side stabilising devices 14 comprising two pins 15 combined with the rear supporting elements 5.

The pins 15 are movable between a position of engagement with a side wall of the bathroom fixture 20 and a position of disengagement with respect to the bathroom fixture 20.

In the embodiments shown in the figures, the sitting aid device also has two armrests 40 hinged to the rear supporting elements 5.

The armrests 40 are configured to be arranged substantially parallel to the first installation surface 1 when the sitting aid device is in the open configuration.

This sitting aid device 10 for bathroom fixtures, as it is clear from the above description, has the following advantages:

the user can operate the control unit 50 to modify the height and inclination of the sitting element 30. This way, it is possible to adjust in a desired manner, by following the natural body posture, the approaching of the sitting element 30 to the body portion of the user who must be in contact with the same sitting element (e.g., the buttocks). The user after having adjusted the sitting element 30 depending on his/her own needs, and therefore having reached the position B of the above-mentioned embodiments of the sitting aid element 30, can return it to the initial position A so that the bathroom fixture 20 can be used advantageously. At the end, in order to be able to stand up easily, the user can operate again the control unit 50, so as to return the sitting element 30 to position B.

if necessary, the sitting aid device can be easily released from the bathroom fixture and brought to the closed configuration, ready to be easily transported to a second location and installed on a second bathroom fixture, typically a holiday home, a new home, in hospitals, nursing homes for the elderly, clinics, B&B, hotels, etc.

Several changes can be made to the embodiments described in detail, all remaining within the protection scope of the disclosure, defined by the following claims.

What is claimed is:

1. A sitting aid device for a bathroom fixture disposed on a first installation surface, comprising:
a sitting element comprising an opening and configured to come into contact with an upper portion of a user's body;
a motor operatively connected to said sitting element to move said sitting element between a first position, in which said sitting element is substantially parallel to said first installation surface, and a second position, in which said sitting element is at least partially away from an upper end of said bathroom fixture and is inclined with respect to a plane parallel to said first installation surface;
at least one supporting frame to which said sitting element is rotatably constrained; said at least one supporting frame comprising at least one base element configured to come into contact with said first installation surface;
a control unit configured to control said motor means;
wherein:
said at least one supporting frame is able to switch from an open configuration, in which said sitting element is away from said base element, so as to be able to house at least partially said bathroom fixture between said sitting element and said base element, and a closed configuration in which said sitting element is moved closer to said base element.

2. The device according to claim 1, wherein said at least one supporting frame further comprises at least one front supporting element rotatably constrained to said base element; said front supporting element being able to rotate between a rest position, in which it is substantially angularly alongside said base element, and an operating position in which it abuts to support it against said sitting element.

3. The device according to claim 1, wherein said at least one supporting frame further comprises at least two rear supporting elements, each of which is rotatably constrained at one end to said base element; each of said rear supporting elements being further functionally combined with said sitting element.

4. The device according to claim 3, characterised in that each of said at least two rear supporting elements can rotate between a rest position, in which they are substantially angularly alongside said base element, and an operating position in which they are angularly away from said base element so as to place at least one rear portion of said sitting element at a height such as to allow said upper surface of said bathroom fixture to be inserted below said sitting element.

5. The device according to claim 3, wherein each of said at least two rear supporting elements comprises a cylinder piston actuated by said motor to bring said sitting element from said first position to said second position and vice versa.

6. The device according to claim 5, wherein said cylinder piston comprises two mutually sliding portions.

7. The device according to claim 2, wherein the front supporting element comprises two side uprights and a transverse element arranged between said side uprights, each side post comprising two telescopic tubular members configured to vary a position of said transverse member.

8. The device according to claim 1, further comprising two side stabilising devices comprising two pins combined with said rear supporting elements, said pins being movable between a position of engagement with a side wall of said bathroom fixture and a position of disengagement with respect to said bathroom fixture.

9. The device according to claim 1, characterised in that said base element comprises two side portions elongated and configured to be arranged laterally to said bathroom fixture so as to delimit it in a transverse direction, and at least one connecting transverse portion arranged substantially transversely between said two side portions so as to connect them.

10. The device according to claim 1, characterised in that said base element comprises two connecting rods configured to be arranged between said base element and said rear supporting elements.
